(19) United States
(12) Patent Application Publication
(10) Pub. No.: US 2026/0117532 A1
(43) Pub. Date: Apr. 30, 2026

(54) UNIVERSAL PROCESSING STAND

(71) Applicant: U.S. Titan Manufacturing, LLC, Fort Morgan, CO (US)

(72) Inventor: Coy Palmer, Fort Morgan, CO (US)

(21) Appl. No.: 18/930,809

(22) Filed: Oct. 29, 2024

(51) Int. Cl. E04G 1/17; E04G 5/00; E04G 5/10; E04G 5/14; E04G 7/00

(52) U.S. Cl. CPC E04G 1/17; E04G 5/005; E04G 5/10; E04G 5/14; E04G 7/00

(57) ABSTRACT

A universal processing stand is provided. The stand may be for use to support a worker during performance of an industrial processing task. For example, the stand may be for use during meat processing. The universal processing stand has features to enhance cleanliness and sanitation, as well as to adapt the stand to accommodate users having different heights and different reach. A stand may have a working platform with a floor for sitting or standing upon and a support pedestal assembly extending downwardly from the working platform to provide support to the working platform elevated above the support pedestal assembly. A platform guard panel may extend along a side of the working platform to guide an article moving adjacent to the working platform along the side of the working platform.

### BACKGROUND

### 1. Field

The various aspects and embodiments described herein relate to processing stands and more specifically, to universal processing stands for operators in industrial and agricultural settings.

### 2. Description of the Related Art

Operators in industrial and agricultural settings often must sit or stand at workstations. In various instances, workpieces pass by the workstations and the operator interacts with the workpiece from positions on processing stands at the workstations. In one instance, a meat processing plant has a conveyor system that moves carcasses along a path. Along the path, different workstations are positioned where operators perform different tasks to prepare meat from the carcass for packaging. In various instances, other food preparation or different tasks occur from the workstations.

In many of these instances, food safety or sanitization requirements are important and extensive. For instance, in a meat packing plant where operators process carcasses to prepare meat for packaging, the processing stands and other areas of the facility are frequently washed and sanitized. However, conventional stands often have structural and other features that impede adequate washing or sanitization. Moreover, conventional stands present challenges in accommodating operators having different physical characteristics such as different height and different reach. Thus, a need exists for a universal processing stand according to the disclosure herein.

### SUMMARY

A universal processing stand is provided. The stand is for use to support a worker during performance of an industrial processing task. The universal processing stand may include a working platform having a floor for sitting or standing upon. The universal processing stand may include a support pedestal assembly extending downwardly from the working platform to provide support to the working platform elevated above the support pedestal assembly. The universal processing stand may include a platform guard panel extending along a side of the working platform to guide an article moving adjacent to the working platform along the side of the working platform.

The support pedestal assembly may include a pedestal leg. The support pedestal assembly may include a spacer attachable to the pedestal leg between the pedestal leg and the working platform and having a first dimension to space a height of the floor to a desired height. The support pedestal assembly may include an adjustable affixment apparatus joining the spacer to the pedestal leg.

The adjustable affixment apparatus may include an elongate aperture of the spacer to receive a fastener fastening the spacer to the pedestal leg. The elongate aperture facilitates forward-to-aft registration of the working platform having the floor forward & nearer to or aft & farther from the article moving adjacent to the working platform along the side of the working platform. The adjustable affixment apparatus may include a shim disposed between the pedestal leg and the spacer and loaded in compression between the pedestal leg and the fastener. The shim provides a cleaning gap between the pedestal leg and the spacer to facilitate cleaning therebetween.

The platform guard panel may include a central face extending along a first direction parallel to the floor of the working platform and along a second direction perpendicular to the floor of the working platform. The central face provides a contact surface for the article moving adjacent to the working platform along the side of the working platform. The central face extends along the first direction a longer distance and along the second direction a shorter distance.

The platform guard panel may include a bent lower guidance face having a planar flange extending downwardly away from the central face and toward the support pedestal assembly. The planar flange may be angling away from the central face and shielding at least a portion of the working platform and at least a portion of the support pedestal assembly from the article moving adjacent to the working platform along the side of the working platform. The platform guard panel may include an upper relief face having a face unitary with the planar flange and cantilevered from the planar flange on an opposite side relative to the bent lower guidance face. The platform guard panel may include a lower reinforcing flange having a face unitary with the bent lower guidance face and extending downwardly away from the bent lower guidance face in a direction parallel to the second direction to strengthen resistance to bending of the bent lower guidance face.

The platform guard panel may include an angled end guidance section disposed at an end of the central face along the first direction. The angled end guidance section may include a central end guidance section face having a flange bent away from the central face to provide guidance to the article moving adjacent to the working platform as the article approaches along the side of the working platform. The angled end guidance section may include an end guidance section bent lower face having a flange bent away from the bent lower guidance face. The angled end guidance section may include an end guidance section upper relief face having a flange bent away from the upper relief face. The central end guidance section face, the end guidance section bent lower face, the end guidance section upper relief face, the upper relief face, the bent lower guidance face, and the planar flange may be an integrally formed single continuous sheet of bent metal.

The spacer may be formed metal having at least one of a c-channel cross-section and a hat-section cross-section. A cleaning aperture may be defined through at least one bend of the formed metal and may provide fluid flow from one side of the formed metal to another side of the formed metal to facilitate cleaning of the spacer. A stair assembly may extend from adjacent to the floor of the working platform and downwardly, the stair assembly having stairs and a stair railing to permit the worker to climb to the floor for sitting or standing upon.

In various embodiments, one or more further examples of universal processing stands may be provided. A universal processing stand for use to support a worker during performance of an industrial processing task may include various features. For instance, the universal processing stand may include a working platform having a floor for sitting or standing upon. The universal processing stand may include a support pedestal assembly extending downwardly from the working platform to provide support to the working platform elevated above the support pedestal assembly. The universal processing stand may include a platform guard panel extending along a side of the working platform to guide an article moving adjacent to the working platform along the side of the working platform.

The support pedestal assembly may include a pedestal leg. The support pedestal assembly may include a spacer attachable to the pedestal leg between the pedestal leg and the working platform and having a first dimension to space a height of the floor to a desired height. The support pedestal assembly may include an adjustable affixment apparatus joining the spacer to the pedestal leg.

The adjustable affixment apparatus may include a fastener extending through an elongate aperture of the spacer and fastening the spacer to the pedestal leg. The elongate aperture facilitates forward-to-aft registration of the working platform having the floor (i) forward and nearer to or (ii) aft and farther from the article moving adjacent to the working platform along the side of the working platform. The adjustable affixment apparatus may include a shim disposed between the pedestal leg and the spacer and loaded in compression between the pedestal leg and the fastener. The shim provides a cleaning gap between the pedestal leg and the spacer to facilitate cleaning therebetween.

In various embodiments, the platform guard panel includes a central face extending along a first direction parallel to the floor of the working platform and along a second direction perpendicular to the floor of the working platform. The central face may provide a contact surface for the article moving adjacent to the working platform along the side of the working platform. The central face may extend along the first direction a longer distance and along the second direction a shorter distance. In various embodiments, the platform guard panel further includes a bent lower guidance face having a planar flange extending downwardly away from the central face and toward the support pedestal assembly. The planar flange may be angling away from the central face and shielding at least a portion of the working platform and at least a portion of the support pedestal assembly from the article moving adjacent to the working platform along the side of the working platform.

The platform guard panel may also have an upper relief face with a face unitary with the planar flange and cantilevered from the planar flange on an opposite side relative to the bent lower guidance face.

The platform guard panel may also have a lower reinforcing flange having a face unitary with the bent lower guidance face and extending downwardly away from the bent lower guidance face in a direction parallel to the second direction to strengthen resistance to bending of the bent lower guidance face.

The platform guard panel may include a pair of angled end guidance sections. Each angled end guidance section of the pair is disposed at opposite ends of the central face along the first direction. Each angled end guidance section includes a flange bent away from the central face.

The platform guard panel may include an angled end guidance section disposed at an end of the central face along the first direction and including a flange bent away from the central face to provide guidance to the article moving adjacent to the working platform as the article approaches along the side of the working platform.

The platform guard panel may include an angled end guidance section disposed at an end of the central face along the first direction. The angled end guidance section may include a central end guidance section face having a flange bent away from the central face to provide guidance to the article moving adjacent to the working platform as the article approaches along the side of the working platform. The angled end guidance section may have an end guidance section bent lower face with a flange bent away from the bent lower guidance face. The angled end guidance section may have an end guidance section upper relief face with a flange bent away from the upper relief face. In various instances, the central end guidance section face, the end guidance section bent lower face, the end guidance section upper relief face, the upper relief face, the bent lower guidance face, and the planar flange are an integrally formed single continuous sheet of bent metal.

The universal processing stand may have the aforementioned spacer and the spacer may have plurality of cleaning apertures defined through the spacer to facilitate fluid flow from one side of the spacer to another side of the spacer for cleaning of the spacer.

The spacer may be made of formed metal having at least one of a c-channel cross-section and a hat-section cross-section. A cleaning aperture may be defined through at least one bend of the formed metal and may provide fluid flow from one side of the formed metal to another side of the formed metal to facilitate cleaning of the spacer.

A universal processing stand may be provided. The stand may be for use to support a worker during performance of an industrial processing task. The universal processing stand may include a working platform having a floor for sitting or standing upon. The universal processing stand may include a support pedestal assembly extending downwardly from the working platform to provide support to the working platform elevated above the support pedestal assembly. The support pedestal assembly may include a pedestal leg. The support pedestal assembly may include a spacer attachable to the pedestal leg between the pedestal leg and the working platform and having a first dimension to space a height of the floor to a desired height. The support pedestal assembly may include an adjustable affixment apparatus joining the spacer to the pedestal leg.

The adjustable affixment apparatus may include a fastener extending through an elongate aperture of the spacer and fastening the spacer to the pedestal leg. The elongate aperture may facilitate forward-to-aft registration of the working platform having the floor near to or farther from an article moving adjacent to the working platform along the side of the working platform. The adjustable affixment apparatus may include a shim disposed between the pedestal leg and the spacer and loaded in compression between the pedestal leg and the fastener. The shim may provide a cleaning gap between the pedestal leg and the spacer to facilitate cleaning therebetween.

In various instances, the spacer includes a plurality of cleaning apertures defined through the spacer to facilitate fluid flow from one side of the spacer to another side of the spacer for cleaning of the spacer. In various instances, the spacer includes formed metal having at least one of a c-channel cross-section and a hat-section cross-section. A cleaning aperture may be defined through at least one bend of the formed metal and provides fluid flow from one side of the formed metal to another side of the formed metal to facilitate cleaning of the spacer.

The universal processing stand may include a stair assembly. The stair assembly may extend from adjacent to the floor of the working platform and downwardly, the stair assembly having stairs and a stair railing to permit the worker to climb to the floor for sitting or standing upon.

### BRIEF DESCRIPTION OF THE DRAWINGS

Other apparatus, methods, features, and advantages of the present disclosure will be apparent to one skilled in the art upon examination of the following figures and detailed description. Component parts shown in the drawings are not necessarily to scale and may be exaggerated to better illustrate the important features of the present disclosure.

FIGS. 1A-1C illustrate views of universal processing stands, in accordance with various embodiments;

FIG. 2 shows an example adjustable affixment apparatus of a universal processing stand, in accordance with various embodiments; and

FIGS. 3A-3B show example platform guard panels of a universal processing stand, in accordance with various embodiments.

### DETAILED DESCRIPTION

Operators in industrial and agricultural settings often must sit or stand at workstations. In various instances, workpieces pass by the workstations and the operator interacts with the workpiece from positions on processing stands at the workstations. In one instance, a meat processing plant has a conveyor system that moves carcasses along a path. Along the path, different workstations are positioned where operators perform different tasks to prepare meat from the carcass for packaging. In various instances, other food preparation or different tasks occur from the workstations.

In many of these instances, food safety or sanitization requirements are important and extensive. For instance, in a meat packing plant where operators process carcasses to prepare meat for packaging, the processing stands and other areas of the facility are frequently washed and sanitized. However, conventional stands often have structural and other features that impede adequate washing or sanitization. Moreover, conventional stands present challenges in accommodating operators having different physical characteristics such as different height and different reach. Thus, a need exists for a universal processing stand according to the disclosure herein.

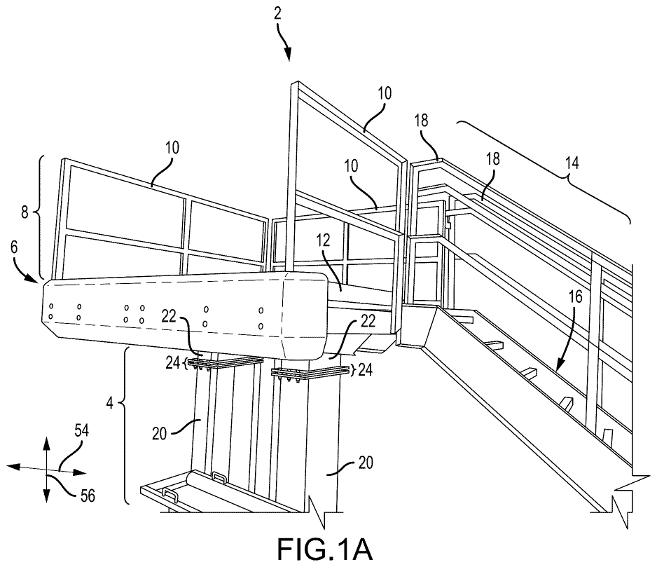

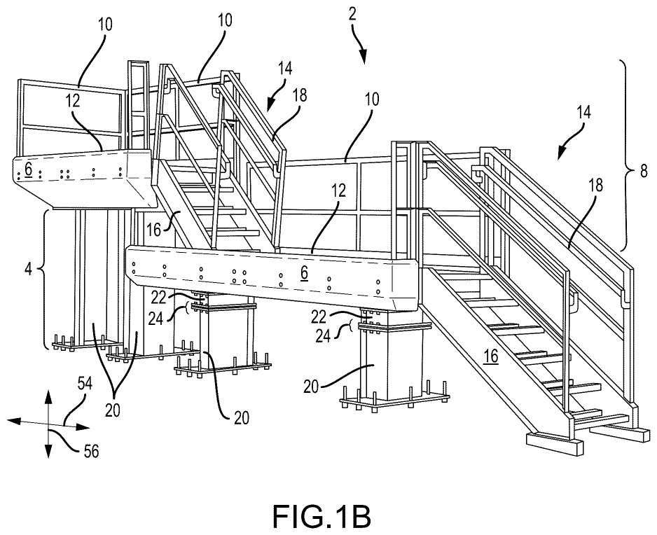

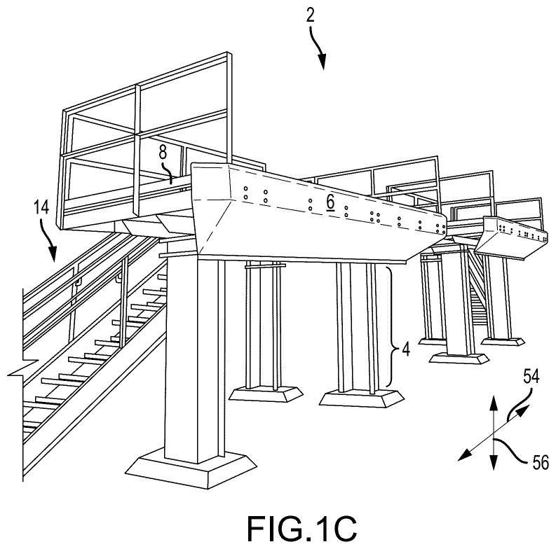

With reference to FIGS. 1A-C, a universal processing stand 2 comprises an elevated structure that can be installed in a facility where workers perform tasks. For instance, the universal processing stand 2 maybe adjacent to an automated conveyor line that moves workpieces among workstations. The universal processing stand 2 may be adjacent to a conveyor system that moves animal carcasses among workstations where the carcasses and/or meat from the carcasses is processed for human consumption. Different types of workpieces or carcasses having different dimensions are contemplated. Moreover, human operators may have different height and/or reach.

The universal processing stand 2 may have different components. For instance, a universal processing stand 2 may have a working platform 8 where an operator stands or sits on a floor 12. The operator may be protected from falling by a railing 10. The operator may access the working platform 8 by climbing stairs 16 of a stair assembly 14. The stair assembly 14 may also have a stair railing 18 for safety during climbing the stairs 16. The universal processing stand 2 may have a support pedestal assembly 4 that supports the working platform 8 in a desired position in space relative to the workpieces and/or carcasses. In various embodiments, a plurality of support pedestal assemblies 4 are contemplated, For instance, a universal processing stand 2 may have two support pedestal assemblies 4, or three support pedestal assemblies 4, or four support pedestal assemblies 4, or any number of support pedestal assemblies 4 as desired. The universal processing stand 2 may have a platform guard panel 6 that shields a portion of the working platform 8 from the workpieces or carcasses. The platform guard panel 6 may ameliorate interfering contact between the workpieces or carcasses and the other features of the universal processing stand 2. Each of these features may include aspects selected to enhance cleaning of the universal processing stand 2.

Turning more specifically to the support pedestal assembly 4, a variety of features are disclosed. For instance, a support pedestal assembly 4 may have a pedestal leg 20. A pedestal leg 20 comprises an elongate member that supports a working platform 8 of the universal processing stand 2. The elongate member may be a pipe, extrusion, formed structure, or any other structure configured to bear weight and provide support. The elongate member may have a C-channel cross-section, or an I-shaped cross section, or a so-called “hat” cross-section, a “U” cross-section, or any other profile as desired. In various embodiments, the pedestal leg 20 includes one or more cleaning aperture 34 defined through the pedestal leg 20. For instance, the pedestal leg 20 may have a plate attached to the elongate member. At the union of the plate and elongate member, a corner may be formed where bacteria and debris may collect. A cleaning aperture 34 may be defined through the plate, elongate member, or both at or near the union of the plate and elongate member to facilitate cleaning and to ameliorate collection of bacteria and debris.

The support pedestal assembly 4 may have a spacer 22. In various embodiments, a spacer 22 comprises an elongate member joinable to a pedestal leg 20. For instance, a pedestal leg 20 may have a plate joined to an elongate member and a spacer 22 may also have a plate joined to an elongate member. The corresponding plates may be selectably connectable by fasteners to enable joining of the spacer 22 to the pedestal leg 20. Thus the spacer 22 may be said to be an extension of the pedestal leg 20. Different spacers 22 may be provided with different dimensions. For instance, longer or shorter spacers 22 may be provided. The spacers 22 may be connectable to a working platform 8 and also connectable to the pedestal leg 20 so that a relative positioning of the working platform 8 may be changed by changing between spacers 22 having different dimensions. Thus a spacer 22 may be selected to position the working platform 8 at a desired location along an up-down axis 38 and spacers 22 may be changed to change the position of the working platform 8 along the up-down axis 38.

The spacer 22, similar to the pedestal leg 20 thus comprises an elongate member that supports a working platform 8 of the universal processing stand 2. The elongate member may be a pipe, extrusion, formed structure, or any other structure configured to bear weight and provide support. The elongate member may have a C-channel cross-section, or an I-shaped cross section, or a so-called “hat” cross-section, or a “U” cross-section, or any other profile as desired. In various embodiments, the spacer 22 includes one or more cleaning aperture 34 defined through the spacer 22. For instance, the spacer 22 may have a plate attached to the elongate member. At the union of the plate and elongate member, a corner may be formed where bacteria and debris may collect. A cleaning aperture 34 may be defined through the plate, elongate member, or both at or near the union of the plate and elongate member to facilitate cleaning and to ameliorate collection of bacteria and debris.

The support pedestal assembly 4 may have an adjustable affixment apparatus 24. The adjustable affixment apparatus 24 may interoperate with aspects of the pedestal leg 20 and spacer 22 to selectably connect the pedestal leg 20 and the spacer 22 together. Moreover, the adjustable affixment apparatus 24 may include or be a part of one or both of the pedestal leg 20 and the spacer 22. Thus, the features discussed with reference to the adjustable affixment apparatus 24 may be understood to be structures mechanically associated with one or both of the pedestal leg 20 and/or spacer 22. In various embodiments, the adjustable affixment apparatus 24 facilitates this selectable connection of the pedestal leg 20 and the spacer 22 together with (1) a cleaning gap 32 defined between the pedestal leg 20 and the spacer 22 to facilitate cleaning and/or (2) aspects to facilitate forward-and-aft registration of the spacer 22 relative to the pedestal leg 20, so that a working platform 8 connected to the spacer 22 may be moved along a forward-aft axis 36 to adjust it to different positions in space similar to the aforementioned adjustment along the up-down axis 38.

The adjustable affixment apparatus 24 may have particular features. For instance, the adjustable affixment apparatus 24 may include a shim 26. The shim 26 may comprise a washer or other member having a height that when inserted between the pedestal leg 20 and the spacer 22 creates an open area defining the cleaning gap 32. In various embodiments, one or more fastener 28, such as a bolt, is inserted into corresponding apertures of the pedestal leg 20 and the spacer 22, and the shim 26 is a washer that encircles a portion of the bolt so that the bolt passes through the shim 26 and is loaded in compression by the bolt and/or by weight of aspects of the structures. The shim 26 causes working platform 8 connected to the spacer 22 to be moved along an up-down axis 38 relative to the pedestal leg 20 to create the cleaning gap 32.

As mentioned, an elongate aperture 30 may be defined in the spacer 22 to facilitate forward-and-aft registration of the spacer 22 relative to the pedestal leg 20, so that the working platform 8 connected to the spacer 22 may be moved along the forward-aft axis 36 to adjust it to different positions in space. For instance, the fastener 28 may pass through the elongate aperture 30 and into an aperture of the pedestal leg 20. In further embodiments, the elongate aperture 30 is defined in the pedestal leg 20. In yet further embodiments, the elongate aperture 30 is defined in the spacer 22 and also in the pedestal leg 20. By being elongate, the elongate aperture 30 permits the fastener 28 to load the union of the spacer 22 and the pedestal leg 20 in compression at different relative positions depending on where along a length of the elongate aperture 30 the fastener 28 passes through the aperture.

Finally, the adjustable affixment apparatus 24 may comprise one or more fastener 28 as mentioned above. The fastener 28 may be a bolt, a pin, a clamp, or any other joining device. In various embodiments, the fastener 28 is a combination of a bolt and a nut and may also include one or more washer. The fastener 28 is associated with an elongate aperture 30.

Reference to various items has been made in the singular above. However, one may also appreciate that the adjustable affixment apparatus 24 may comprise a multiples of one or more of the fastener 28, the shim 26, and the elongate aperture 30. Multiple fasteners 28 may be associated with multiple elongate apertures 30. One or more of the fasteners may have a shim 26 disposed there about to create the cleaning gap 32. In further embodiments, the adjustable affixment apparatus 24 is not adjustable, but is fixed and is a permanent connection of the spacer 22 and the pedestal leg 20. In further embodiments, the adjustable affixment apparatus 24 is not adjustable, but is fixed and is a selectably disconnectable connection of the spacer 22 and the pedestal leg 20.

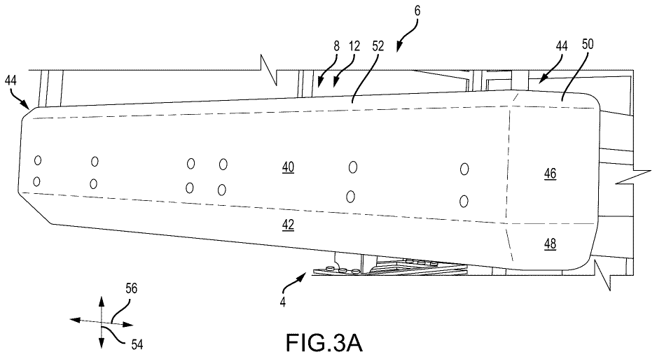

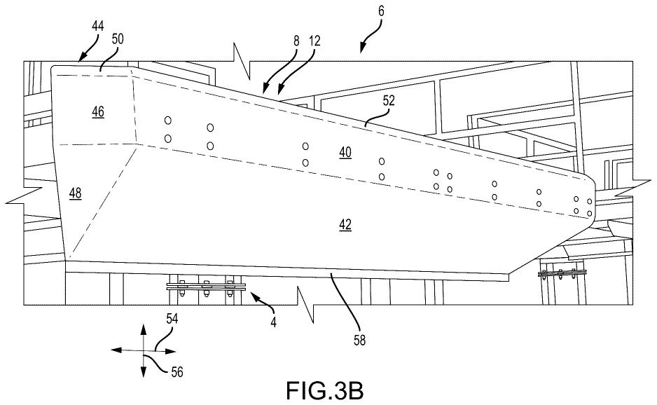

Referring now to FIGS. 3A-3B, different aspects of the platform guard panel 6 are shown in detail. In various embodiments, the platform guard panel 6 comprises a central face 40. The central face 40 may extend along a portion of the working platform 8. For instance, the central face 40 may comprise a plate or similar piece of material that extends along a first direction 54 parallel to a floor 12 of the working platform 8 and along a second direction 56 perpendicular to a floor 12 of the working platform 8. Thus, the central face 40 may lie in a plane defined in the first direction 54 and the second direction 56. The central face 40 may provide a contact surface for the article moving adjacent to the working platform 8 along a side of the working platform 8. For instance, in a meat packing plant, animal carcasses may move adjacent to the working platform 8 and may contact the working platform 8. The central face 40 provides a contact surface and protects the carcass from contact to features of the working platform 8 that may damage the carcass.

The platform guard panel 6 may include a bent lower guidance face 42. The bent lower guidance face 42 may extend from the central face 40. The bent lower guidance face 42 may cantilever from an edge of the central face 40. The bent lower guidance face 42 may cantilever from a longer edge of the central face 40. The bent lower guidance face 42 may cantilever from a lower edge of the central face 40 meaning an edge farther from the floor 12 or area occupied by an operator. The bent lower guidance face 42 may cantilever from a lower edge of the central face 40 meaning an edge closest to the support pedestal assembly 4. The bent lower guidance face 42 may provide a contact surface and protect the carcass form contact to features of the support pedestal assembly 4. For instance, in the processing of beef, legs may extend from a cow carcass into this area and contact aspects of the support pedestal assembly 4, causing contamination and unwanted movement of or damage to the carcass. By implementing a bent lower guidance face 42, this contact and associated physical impulse, may be ameliorated. Thus, bent lower guidance face 42 may be a planar flange extending downwardly away from the central face 40 and toward the support pedestal assembly 4, the planar flange angling away from the central face 40 and shielding at least a portion of the working platform 8 and at least a portion of the support pedestal assembly 4 from the article moving adjacent to the working platform 8 along the side of the working platform 8.

The platform guard panel 6 may include a lower reinforcing flange 58. The lower reinforcing flange 58 may be a face unitary with the bent lower guidance face 42 and extending downwardly away from the bent lower guidance face 42 in a direction parallel to the second direction 56 to strengthen resistance to bending of the bent lower guidance face 42.

The platform guard panel 6 may include an upper relief face 52. The upper relief face 52 may extend from the central face 40. The upper relief face 52 may cantilever from an edge of the central face 40. The upper relief face 52 may cantilever from an opposite edge of the central face 40 than the bent lower guidance face 42. The upper relief face 52 may cantilever from a longer edge of the central face 40. The upper relief face 52 may cantilever from an upper edge of the central face 40 meaning an edge nearer to the floor 12 or area occupied by an operator. The upper relief face 52 may cantilever from an upper edge of the central face 40 meaning an edge farthest from the support pedestal assembly 4. The upper relief face 52 may provide a contact surface and protect the carcass from contact to surface features of the floor 12 of the working platform 8. The upper relief face 52 may provide enhanced structural rigidity to the central face 40 via introduction of an angle at the union of the central face 40 to the upper relief face 52. By implementing an upper relief face 52, contact between an article, such as a carcass and aspects of the working platform 8 may be ameliorated. Thus, the upper relief face 52 may be a face unitary with the planar flange of the central face 40 and cantilevered from the planar flange of the central face 40 on an opposite side relative to the bent lower guidance face 42.

The platform guard panel 6 may have one or more angled end guidance section 44. In various embodiments, an angled end guidance section 44 is an end along the longer direction of the platform guard panel 6. The angled end guidance section 44 may appear as a portion of the central face 40, the bent lower guidance face 42, and the upper relief face 52, except angling from respective planes of the central face 40, bent lower guidance face 42, and upper relief face 52 from the plane of the central face 40 and away from an area in front of the working platform 8 and toward the support pedestal assembly 4 and/or around an edge of the working platform 8.

One such feature may be disposed at each opposite end of the platform guard panel 6. Stated differently, one such feature may be disposed at each opposite end of a front of the working platform 8 and between a workpiece or carcass and the working platform 8. The platform guard panel 6 may include a pair of angled end guidance sections 44, each angled end guidance section 44 of the pair disposed at opposite ends of the central face 40 along the first direction 54. Each angled end guidance section 44 may include a flange that is bent away from the central face 40. This flange may be the central end guidance section face 46.

Thus, the angled end guidance section 44 may include a central end guidance section face 46. The central end guidance section face 46 may comprise a planar flange. The planar flange may be joined to the central face 40 at an angle, so that the planar flange extends away from the central face 40 in a plane that intersects with a plane of the central face 40 along a line defined at an edge of the central face 40. The planar flange may provide guidance to an article moving adjacent to the working platform 8 as the article approaches along a side of the working platform 8. For instance, the planar flange may provide guidance to a carcass moving along a side of the working platform 8 and serve as a ramp to direct the moving carcass toward (or away from) a rub surface provided by the central face 40.

The angled end guidance section 44 may also have an end guidance section bent lower face 48. The end guidance section bent lower face 48 may comprise a planar flange. The planar flange may be joined to the bent lower guidance face 42 at an angle, so that the planar flange extends away from the bent lower guidance face 42 in a plane that intersects with a plane of the bent lower guidance face 42 along a line defined at an edge of the bent lower guidance face 42. The planar flange may provide guidance to an article moving adjacent to the working platform 8 as the article approaches along a side of the working platform 8. For instance, the planar flange may provide guidance to a carcass moving along a side of the working platform 8 and serve as a ramp to direct the moving carcass toward (or away from) a rub surface provided by the bent lower guidance face 42.

The angled end guidance section 44 may also have an end guidance section upper relief face 50. The end guidance section upper relief face 50 comprises a flange. The flange may be a planar flange. The planar flange may be bent away from the upper relief face 52. The planar flange may be joined to the upper relief face 52 at an angle, so that the planar flange extends away from the upper relief face 52 in a plane that intersects with a plane of the upper relief face 52 along a line defined at an edge of the upper relief face 52. The planar flange may provide guidance to an article moving adjacent to the working platform 8 as the article approaches along a side of the working platform 8. For instance, the planar flange may provide guidance to a carcass moving along a side of the working platform 8 and serve as a ramp to direct the moving carcass toward (or away from) a rub surface provided by the upper relief face 52.

Having introduced each aspect of the platform guard panel 6, in various embodiments, the platform guard panel 6 is an integrally formed panel. For instance, the central end guidance section face 46, the end guidance section bent lower face 48, the end guidance section upper relief face 50, the upper relief face 52, the bent lower guidance face 42, and the planar flange (central face 40) are an integrally formed single continuous sheet of bent metal. In various embodiments, the platform guard panel 6 is bolted to the working platform 8 or riveted to the working platform 8 or another structure of the universal processing stand 2.

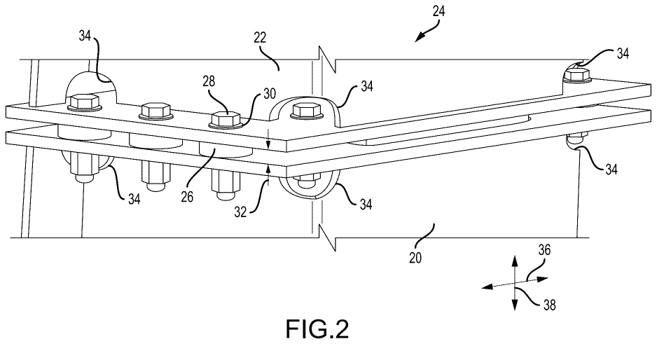

Having introduced aspects of a universal processing stand 2, now is a convenient point to discuss various example embodiments of the stand. Referring to FIGS. 1A-3B, a universal processing stand 2 is provided. The stand is for use to support a worker during performance of an industrial processing task. The universal processing stand 2 may include a working platform 8 having a floor 12 for sitting or standing upon. The universal processing stand 2 may include a support pedestal assembly 4 extending downwardly from the working platform 8 to provide support to the working platform 8 elevated above the support pedestal assembly 4. The universal processing stand 2 may include a platform guard panel 6 extending along a side of the working platform 8 to guide an article moving adjacent to the working platform 8 along the side of the working platform 8.

The support pedestal assembly 4 may include a pedestal leg 20. The support pedestal assembly 4 may include a spacer 22 attachable to the pedestal leg 20 between the pedestal leg 20 and the working platform 8 and having a first dimension to space a height of the floor 12 to a desired height. The support pedestal assembly 4 may include an adjustable affixment apparatus 24 joining the spacer 22 to the pedestal leg 20.

The adjustable affixment apparatus 24 may include an elongate aperture 30 of the spacer 22 to receive a fastener 28 fastening the spacer 22 to the pedestal leg 20. The elongate aperture 30 facilitates forward-to-aft registration of the working platform 8 having the floor 12 forward & nearer to or aft & farther from the article moving adjacent to the working platform 8 along the side of the working platform 8. The adjustable affixment apparatus 24 may include a shim 26 disposed between the pedestal leg 20 and the spacer 22 and loaded in compression between the pedestal leg 20 and the fastener 28. The shim 26 provides a cleaning gap 32 between the pedestal leg 20 and the spacer 22 to facilitate cleaning therebetween.

The platform guard panel 6 may include a central face 40 extending along a first direction 54 parallel to the floor 12 of the working platform 8 and along a second direction 56 perpendicular to the floor 12 of the working platform 8. The central face 40 provides a contact surface for the article moving adjacent to the working platform 8 along the side of the working platform 8. The central face 40 extends along the first direction 54 a longer distance and along the second direction 56 a shorter distance.

The platform guard panel 6 may include a bent lower guidance face 42 having a planar flange extending downwardly away from the central face 40 and toward the support pedestal assembly 4. The planar flange may be angling away from the central face 40 and shielding at least a portion of the working platform 8 and at least a portion of the support pedestal assembly 4 from the article moving adjacent to the working platform 8 along the side of the working platform 8. The platform guard panel 6 may include an upper relief face 52 having a face unitary with the planar flange and cantilevered from the planar flange on an opposite side relative to the bent lower guidance face 42. The platform guard panel 6 may include a lower reinforcing flange 58 having a face unitary with the bent lower guidance face 42 and extending downwardly away from the bent lower guidance face 42 in a direction parallel to the second direction 56 to strengthen resistance to bending of the bent lower guidance face 42.

The platform guard panel 6 may include an angled end guidance section 44 disposed at an end of the central face 40 along the first direction 54. The angled end guidance section 44 may include a central end guidance section face 46 having a flange bent away from the central face 40 to provide guidance to the article moving adjacent to the working platform 8 as the article approaches along the side of the working platform 8. The angled end guidance section 44 may include an end guidance section bent lower face 48 having a flange bent away from the bent lower guidance face 42. The angled end guidance section 44 may include an end guidance section upper relief face 50 having a flange bent away from the upper relief face 52. The central end guidance section face 46, the end guidance section bent lower face 48, the end guidance section upper relief face 50, the upper relief face 52, the bent lower guidance face 42, and the planar flange may be an integrally formed single continuous sheet of bent metal.

The spacer 22 may be formed metal having at least one of a c-channel cross-section and a hat-section cross-section. A cleaning aperture 34 may be defined through at least one bend of the formed metal and may provide fluid flow from one side of the formed metal to another side of the formed metal to facilitate cleaning of the spacer 22. A stair assembly 14 may extend from adjacent to the floor 12 of the working platform 8 and downwardly, the stair assembly 14 having stairs 16 and a stair railing 18 to permit the worker to climb to the floor 12 for sitting or standing upon.

Having introduced various different features of the universal processing stands and having discussed each figure in detail, it is also useful to discuss some example implementations of the stands and other features provided in this disclosure. These examples are not exhaustive, but do provide different options for implementing the disclosed features. Thus, with combined reference to FIGS. 1A-3B, one or more further examples of various universal processing stands may be provided in the following paragraphs.

A universal processing stand 2 for use to support a worker during performance of an industrial processing task may include various features. For instance, the universal processing stand 2 may include a working platform 8 having a floor 12 for sitting or standing upon. The universal processing stand 2 may include a support pedestal assembly 4 extending downwardly from the working platform 8 to provide support to the working platform 8 elevated above the support pedestal assembly 4. The universal processing stand 2 may include a platform guard panel 6 extending along a side of the working platform 8 to guide an article moving adjacent to the working platform 8 along the side of the working platform 8.

The support pedestal assembly 4 may include a pedestal leg 20. The support pedestal assembly 4 may include a spacer 22 attachable to the pedestal leg 20 between the pedestal leg 20 and the working platform 8 and having a first dimension to space a height of the floor 12 to a desired height. The support pedestal assembly 4 may include an adjustable affixment apparatus 24 joining the spacer 22 to the pedestal leg 20.

The adjustable affixment apparatus 24 may include a fastener 28 extending through an elongate aperture 30 of the spacer 22 and fastening the spacer 22 to the pedestal leg 20. The elongate aperture 30 facilitates forward-to-aft registration of the working platform 8 having the floor 12 (i) forward and nearer to or (ii) aft and farther from the article moving adjacent to the working platform 8 along the side of the working platform 8. The adjustable affixment apparatus 24 may include a shim 26 disposed between the pedestal leg 20 and the spacer 22 and loaded in compression between the pedestal leg 20 and the fastener 28. The shim 26 provides a cleaning gap 32 between the pedestal leg 20 and the spacer 22 to facilitate cleaning therebetween.

In various embodiments, the platform guard panel 6 includes a central face 40 extending along a first direction 54 parallel to the floor 12 of the working platform 8 and along a second direction 56 perpendicular to the floor 12 of the working platform 8. The central face 40 may provide a contact surface for the article moving adjacent to the working platform 8 along the side of the working platform 8. The central face 40 may extend along the first direction 54 a longer distance and along the second direction 56 a shorter distance. In various embodiments, the platform guard panel 6 further includes a bent lower guidance face 42 having a planar flange extending downwardly away from the central face 40 and toward the support pedestal assembly 4. The planar flange may be angling away from the central face 40 and shielding at least a portion of the working platform 8 and at least a portion of the support pedestal assembly 4 from the article moving adjacent to the working platform 8 along the side of the working platform 8.

The platform guard panel 6 may also have an upper relief face 52 with a face unitary with the planar flange and cantilevered from the planar flange on an opposite side relative to the bent lower guidance face 42.

The platform guard panel 6 may also have a lower reinforcing flange 58 having a face unitary with the bent lower guidance face 42 and extending downwardly away from the bent lower guidance face 42 in a direction parallel to the second direction 56 to strengthen resistance to bending of the bent lower guidance face 42.

The platform guard panel 6 may include a pair of angled end guidance sections 44. Each angled end guidance section 44 of the pair is disposed at opposite ends of the central face 40 along the first direction 54. Each angled end guidance section 44 includes a flange bent away from the central face 40.

The platform guard panel 6 may include an angled end guidance section 44 disposed at an end of the central face 40 along the first direction 54 and including a flange bent away from the central face 40 to provide guidance to the article moving adjacent to the working platform 8 as the article approaches along the side of the working platform 8.

The platform guard panel 6 may include an angled end guidance section 44 disposed at an end of the central face 40 along the first direction 54. The angled end guidance section 44 may include a central end guidance section face 46 having a flange bent away from the central face 40 to provide guidance to the article moving adjacent to the working platform 8 as the article approaches along the side of the working platform 8. The angled end guidance section 44 may have an end guidance section bent lower face 48 with a flange bent away from the bent lower guidance face 42. The angled end guidance section 44 may have an end guidance section upper relief face 50 with a flange bent away from the upper relief face 52. In various instances, the central end guidance section face 46, the end guidance section bent lower face 48, the end guidance section upper relief face 50, the upper relief face 52, the bent lower guidance face 42, and the planar flange are an integrally formed single continuous sheet of bent metal.

The universal processing stand 2 may have the aforementioned spacer 22 and the spacer 22 may have plurality of cleaning apertures defined through the spacer 22 to facilitate fluid flow from one side of the spacer 22 to another side of the spacer 22 for cleaning of the spacer 22.

The spacer 22 may be made of formed metal having at least one of a c-channel cross-section and a hat-section cross-section. A cleaning aperture 34 may be defined through at least one bend of the formed metal and may provide fluid flow from one side of the formed metal to another side of the formed metal to facilitate cleaning of the spacer 22.

A universal processing stand 2 may be provided. The stand may be for use to support a worker during performance of an industrial processing task. The universal processing stand 2 may include a working platform 8 having a floor 12 for sitting or standing upon. The universal processing stand 2 may include a support pedestal assembly 4 extending downwardly from the working platform 8 to provide support to the working platform 8 elevated above the support pedestal assembly 4. The support pedestal assembly 4 may include a pedestal leg 20. The support pedestal assembly 4 may include a spacer 22 attachable to the pedestal leg 20 between the pedestal leg 20 and the working platform 8 and having a first dimension to space a height of the floor 12 to a desired height. The support pedestal assembly 4 may include an adjustable affixment apparatus 24 joining the spacer 22 to the pedestal leg 20.

The adjustable affixment apparatus 24 may include a fastener 28 extending through an elongate aperture 30 of the spacer 22 and fastening the spacer 22 to the pedestal leg 20. The elongate aperture 30 may facilitate forward-to-aft registration of the working platform 8 having the floor 12 near to or farther from an article moving adjacent to the working platform 8 along the side of the working platform 8. The adjustable affixment apparatus 24 may include a shim 26 disposed between the pedestal leg 20 and the spacer 22 and loaded in compression between the pedestal leg 20 and the fastener 28. The shim 26 may provide a cleaning gap 32 between the pedestal leg 20 and the spacer 22 to facilitate cleaning therebetween.

In various instances, the spacer 22 includes a plurality of cleaning apertures defined through the spacer 22 to facilitate fluid flow from one side of the spacer 22 to another side of the spacer 22 for cleaning of the spacer 22. In various instances, the spacer 22 includes formed metal having at least one of a c-channel cross-section and a hat-section cross-section. A cleaning aperture 34 may be defined through at least one bend of the formed metal and provides fluid flow from one side of the formed metal to another side of the formed metal to facilitate cleaning of the spacer 22.

The universal processing stand 2 may include a stair assembly 14. The stair assembly 14 may extend from adjacent to the floor 12 of the working platform 8 and downwardly, the stair assembly 14 having stairs 16 and a stair railing 18 to permit the worker to climb to the floor 12 for sitting or standing upon.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A universal processing stand for use to support a worker during performance of an industrial processing task, the stand comprising:
a working platform having a floor for sitting or standing upon;
a support pedestal assembly extending downwardly from the working platform to provide support to the working platform elevated above the support pedestal assembly; and
a platform guard panel extending along a side of the working platform to guide an article moving adjacent to the working platform along the side of the working platform,
wherein the support pedestal assembly comprises:
a pedestal leg;
a spacer attachable to the pedestal leg between the pedestal leg and the working platform and having a first dimension to space a height of the floor to a desired height; and
an adjustable affixment apparatus joining the spacer to the pedestal leg,
wherein the adjustable affixment apparatus comprises:
an elongate aperture of the spacer to receive a fastener fastening the spacer to the pedestal leg, wherein the elongate aperture facilitates forward-to-aft registration of the working platform having the floor forward & nearer to or aft & farther from the article moving adjacent to the working platform along the side of the working platform; and
a shim disposed between the pedestal leg and the spacer and loaded in compression between the pedestal leg and the fastener, wherein the shim provides a cleaning gap between the pedestal leg and the spacer to facilitate cleaning therebetween,
wherein the platform guard panel comprises a central face extending along a first direction parallel to the floor of the working platform and along a second direction perpendicular to the floor of the working platform, wherein the central face provides a contact surface for the article moving adjacent to the working platform along the side of the working platform,
wherein the central face extends along the first direction a longer distance and along the second direction a shorter distance,
wherein the platform guard panel comprises:
a bent lower guidance face comprising a planar flange extending downwardly away from the central face and toward the support pedestal assembly, the planar flange angling away from the central face and shielding at least a portion of the working platform and at least a portion of the support pedestal assembly from the article moving adjacent to the working platform along the side of the working platform;
an upper relief face comprising a face unitary with the planar flange and cantilevered from the planar flange on an opposite side relative to the bent lower guidance face; and
a lower reinforcing flange comprising a face unitary with the bent lower guidance face and extending downwardly away from the bent lower guidance face in a direction parallel to the second direction to strengthen resistance to bending of the bent lower guidance face,
wherein the platform guard panel comprises an angled end guidance section disposed at an end of the central face along the first direction, the angled end guidance section comprising:
a central end guidance section face comprising a flange bent away from the central face to provide guidance to the article moving adjacent to the working platform as the article approaches along the side of the working platform;
an end guidance section bent lower face, comprising a flange bent away from the bent lower guidance face; and
an end guidance section upper relief face comprising a flange bent away from the upper relief face,
wherein the central end guidance section face, the end guidance section bent lower face, the end guidance section upper relief face, the upper relief face, the bent lower guidance face, and the planar flange are an integrally formed single continuous sheet of bent metal,
wherein the spacer comprises formed metal having at least one of a c-channel cross-section and a hat-section cross-section, wherein a cleaning aperture is defined through at least one bend of the formed metal and provides fluid flow from one side of the formed metal to another side of the formed metal to facilitate cleaning of the spacer; and
a stair assembly extending from adjacent to the floor of the working platform and downwardly, the stair assembly having stairs and a stair railing to permit the worker to climb to the floor for sitting or standing upon.

2. A universal processing stand for use to support a worker during performance of an industrial processing task, the stand comprising:
a working platform having a floor for sitting or standing upon;
a support pedestal assembly extending downwardly from the working platform to provide support to the working platform elevated above the support pedestal assembly; and
a platform guard panel extending along a side of the working platform to guide an article moving adjacent to the working platform along the side of the working platform.

3. The universal processing stand according to claim 2, wherein the support pedestal assembly comprises:
a pedestal leg;
a spacer attachable to the pedestal leg between the pedestal leg and the working platform and having a first dimension to space a height of the floor to a desired height; and
an adjustable affixment apparatus joining the spacer to the pedestal leg.

4. The universal processing stand according to claim 3, wherein the adjustable affixment apparatus comprises:
a fastener extending through an elongate aperture of the spacer and fastening the spacer to the pedestal leg, wherein the elongate aperture facilitates forward-to-aft registration of the working platform having the floor (i) forward and nearer to or (ii) aft and farther from the article moving adjacent to the working platform along the side of the working platform; and
a shim disposed between the pedestal leg and the spacer and loaded in compression between the pedestal leg and the fastener, wherein the shim provides a cleaning gap between the pedestal leg and the spacer to facilitate cleaning therebetween.

5. The universal processing stand according to claim 2,
wherein the platform guard panel comprises a central face extending along a first direction parallel to the floor of the working platform and along a second direction perpendicular to the floor of the working platform, and
wherein the central face provides a contact surface for the article moving adjacent to the working platform along the side of the working platform.

6. The universal processing stand according to claim 5, wherein the central face extends along the first direction a longer distance and along the second direction a shorter distance.

7. The universal processing stand according to claim 5,
wherein the platform guard panel further comprises a bent lower guidance face comprising a planar flange extending downwardly away from the central face and toward the support pedestal assembly,
the planar flange angling away from the central face and shielding at least a portion of the working platform and at least a portion of the support pedestal assembly from the article moving adjacent to the working platform along the side of the working platform.

8. The universal processing stand according to claim 7, wherein the platform guard panel further comprises an upper relief face comprising a face unitary with the planar flange and cantilevered from the planar flange on an opposite side relative to the bent lower guidance face.

9. The universal processing stand according to claim 7, wherein the platform guard panel further comprises a lower reinforcing flange comprising a face unitary with the bent lower guidance face and extending downwardly away from the bent lower guidance face in a direction parallel to the second direction to strengthen resistance to bending of the bent lower guidance face.

10. The universal processing stand according to claim 5,
wherein the platform guard panel further comprises a pair of angled end guidance sections,
each angled end guidance section of the pair disposed at opposite ends of the central face along the first direction, wherein each angled end guidance section includes a flange bent away from the central face.

11. The universal processing stand according to claim 5, wherein the platform guard panel further comprises an angled end guidance section disposed at an end of the central face along the first direction and including a flange bent away from the central face to provide guidance to the article moving adjacent to the working platform as the article approaches along the side of the working platform.

12. The universal processing stand according to claim 8, wherein the platform guard panel further comprises an angled end guidance section disposed at an end of the central face along the first direction, the angled end guidance section comprising:
a central end guidance section face comprising a flange bent away from the central face to provide guidance to the article moving adjacent to the working platform as the article approaches along the side of the working platform;
an end guidance section bent lower face, comprising a flange bent away from the bent lower guidance face; and
an end guidance section upper relief face comprising a flange bent away from the upper relief face.

13. The universal processing stand according to claim 12, wherein the central end guidance section face, the end guidance section bent lower face, the end guidance section upper relief face, the upper relief face, the bent lower guidance face, and the planar flange are an integrally formed single continuous sheet of bent metal.

14. The universal processing stand according to claim 3, wherein the spacer comprises a plurality of cleaning apertures defined through the spacer to facilitate fluid flow from one side of the spacer to another side of the spacer for cleaning of the spacer.

15. The universal processing stand according to claim 3,
wherein the spacer comprises formed metal having at least one of a c-channel cross-section and a hat-section cross-section, and
wherein a cleaning aperture is defined through at least one bend of the formed metal and provides fluid flow from one side of the formed metal to another side of the formed metal to facilitate cleaning of the spacer.

16. A universal processing stand for use to support a worker during performance of an industrial processing task, the stand comprising:
a working platform having a floor for sitting or standing upon;
a support pedestal assembly extending downwardly from the working platform to provide support to the working platform elevated above the support pedestal assembly, the support pedestal assembly comprising:
a pedestal leg;
a spacer attachable to the pedestal leg between the pedestal leg and the working platform and having a first dimension to space a height of the floor to a desired height; and
an adjustable affixment apparatus joining the spacer to the pedestal leg.

17. The universal processing stand according to claim 16, wherein the adjustable affixment apparatus comprises:
a fastener extending through an elongate aperture of the spacer and fastening the spacer to the pedestal leg, wherein the elongate aperture facilitates forward-to-aft registration of the working platform having the floor near to or farther from an article moving adjacent to the working platform along the side of the working platform; and
a shim disposed between the pedestal leg and the spacer and loaded in compression between the pedestal leg and the fastener, wherein the shim provides a cleaning gap between the pedestal leg and the spacer to facilitate cleaning therebetween.

18. The universal processing stand according to claim 16, wherein the spacer comprises a plurality of cleaning apertures defined through the spacer to facilitate fluid flow from one side of the spacer to another side of the spacer for cleaning of the spacer.

19. The universal processing stand according to claim 18,
wherein the spacer comprises formed metal having at least one of a c-channel cross-section and a hat-section cross-section, and
wherein a cleaning aperture is defined through at least one bend of the formed metal and provides fluid flow from one side of the formed metal to another side of the formed metal to facilitate cleaning of the spacer.

20. The universal processing stand according to claim 16, further comprising a stair assembly extending from adjacent to the floor of the working platform and downwardly, the stair assembly having stairs and a stair railing to permit the worker to climb to the floor for sitting or standing upon.
